(19) United States
(12) Patent Application Publication
(10) Pub. No.: US 2007/0022388 A1
(43) Pub. Date: Jan. 25, 2007

(54) Presence display icon and method

(75) Inventor: Cullen Jennings, San Jose, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/186,726

(22) Filed: Jul. 20, 2005

(51) Int. Cl. G06F 9/00

(52) U.S. Cl. 715/772

(57) ABSTRACT

A user interface for a communication device is provided. The user interface comprises a presence display icon to display presence states of at least one user. Each presence state of the user indicates the availability status of the user in video, audio and text based modes of communication. An optimal number of presence states are determined by using a Karnaugh map.

### BACKGROUND OF THE INVENTION

1. Field of Invention

Embodiments of the present invention relate in general to a user interface. More specifically, embodiments of the present invention relate to a presence display icon of a user interface.

2. Description of the Background Art

Over the past few years, the need for new and better modes of communication has increased. This has resulted in the development of a communication device, which can be used for one or more modes of communication. Examples of the modes of communication include video communication, audio communication, and text communication. Further, each mode of communication includes various availability status of users. Examples of availability status include available, not available, and busy. In the above-mentioned examples, each user can communicate through three modes of communication, and can have three availability status in each mode of communication.

Typically, the communication device includes a user interface to display information pertaining to the availability status of a user. The information about the user includes the presence states of the user. Each presence state indicates the availability status of the user for each mode of communication. For example, a presence state can indicate that the user is available for audio communication, not available for video communication, and busy for text communication.

One way of displaying the presence states is to provide three display icons to display presence state corresponding to each mode of communication. In this way, nine different visual representations are required to represent these presence states. However, the three display icons require a large screen real estate.

Another way of displaying the presence states is to provide a single display icon. The single display icon requires less screen real estate and is easier to understand. This is because the human mind can comprehend information from a single source more easily. However, in a single display icon (for the example stated above) 27 different visual representations are required to display the possible presence states. However, so many presence states are difficult to comprehend. According to research on the various aspects of the human mind, it can comprehend only a limited amount of information in its short-term memory. Therefore, it may not be possible for a human being to recognize 27 different visual representations. This limits the transfer of information from the display icon to the human mind.

### BRIEF DESCRIPTION OF THE DRAWINGS

FIG. 1 illustrates the environment wherein an embodiment of the invention can be practiced.

FIG. 2 is a block diagram illustrating the sub-components of a first communication device, in accordance with an exemplary embodiment of the invention.

FIG. 3 illustrates a presence display icon, in accordance with an exemplary embodiment of the invention.

FIG. 4 illustrates a flowchart of a method for determining an optimal number of presence states, in accordance with an exemplary embodiment of the invention.

FIG. 5 illustrates an exemplary Karnaugh map for determining the optimal number of presence states, in accordance with an exemplary embodiment of the invention.

FIG. 6 is an embodiment of a display icon comprising a tear drop member and a rectangular member, all representing glyphs having different shades and/or colors.

### DETAILED DESCRIPTION OF EMBODIMENTS OF THE INVENTION

The invention relates to a presence display icon and a method for designing the same. The presence display icon displays the presence states of a user. In accordance with various embodiments of the invention, the optimal number of presence states of a user may be determined by using Karnaugh maps. A Karnaugh map is a pictorial method used to minimize Boolean expressions without having to use Boolean algebra theorems and equation manipulations. Thus, Karnaugh maps provide an alternative way of simplifying logic circuits. Instead of using Boolean algebra simplification techniques, one can transfer logic values from a Boolean statement or a truth table into a Karnaugh map. The arrangement of 0's and 1's within the map helps one to visualize the logic relationships between the variables and leads directly to a simplified Boolean statement. Karnaugh maps are often used to simplify logic problems with 2, 3 or 4 variables.

The presence states indicate the availability status of at least one user for communication with other users. Each user can communicate through multiple modes of communication. Examples of the modes of communication include video communication, audio communication and text communication. Further, each mode of communication can have multiple availability status. Examples of availability status include available, not available and busy. A presence state of the user indicates the current availability status of the user for each mode of communication. For example, the presence state can indicate that the user is currently available for audio communication and not available for video and text communication.

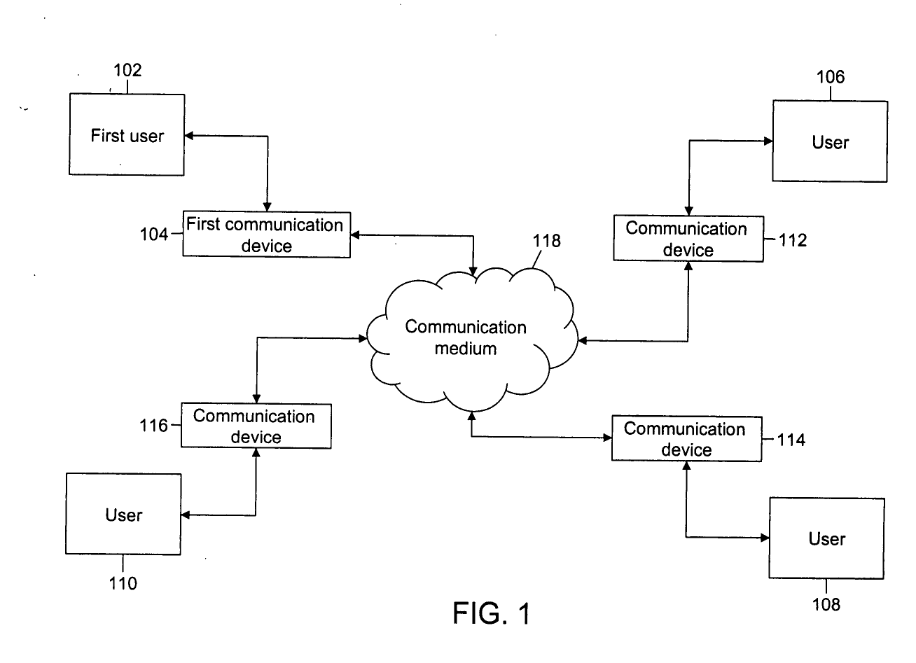

FIG. 1 illustrates the environment wherein an embodiment of the invention can be practiced. The environment includes a first user 102, using a first communication device 104 to communicate with a plurality of users, hereinafter referred to as users 106, 108 and 110. First user 102 and users 106, 108 and 110 can communicate through one or more modes of communication. Each of users 106, 108 and 110 use communication devices hereinafter referred to as communication devices 112, 114 and 116, to communicate with each other and with first user 102. Examples of first communication device 104 and communication devices 112, 114 and 116 include computers, phones, Personal Digital Assistants (PDAs), conferencing devices, and the like. First communication device 104 and communication devices 112, 114 and 116 are connected to each other by a communication medium 118. Examples of communication medium 118 include the Internet, Public Switched Telephone Networks (PSTNs), Digital Switched Networks (DSNs), and the like.

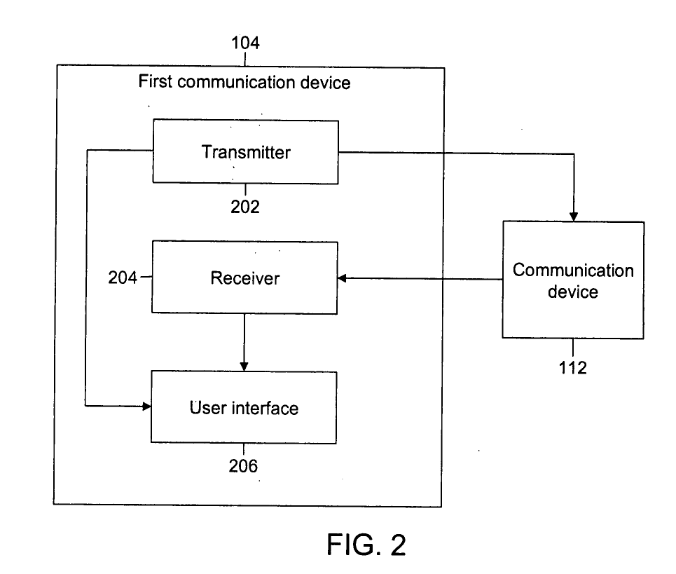

FIG. 2 is a block diagram illustrating the sub-components of first communication device 104, in accordance with an exemplary embodiment of the invention. First communication device 104 includes a transmitter 202, a receiver 204, and a user interface 206. Transmitter 202 is used to establish communication with user 106 through communication device 112. While communicating, transmitter 202 transmits information to user 106 through communication device 112. Receiver 204 receives information from communication device 112 and passes the information to user interface 206. User interface 206 uses this information to display presence state of user 106. In accordance with various embodiments of the invention, communication devices 112, 114 and 116 can have identical sub-components, like those of first communication device 104.

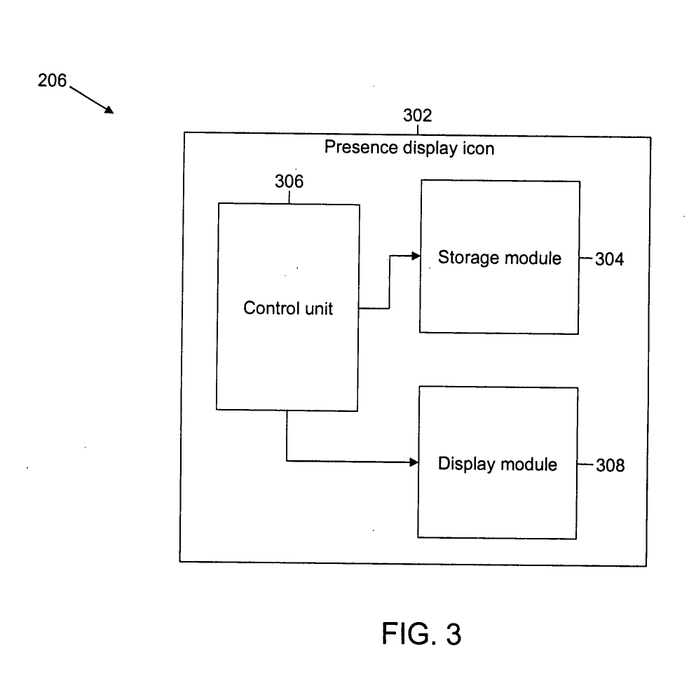

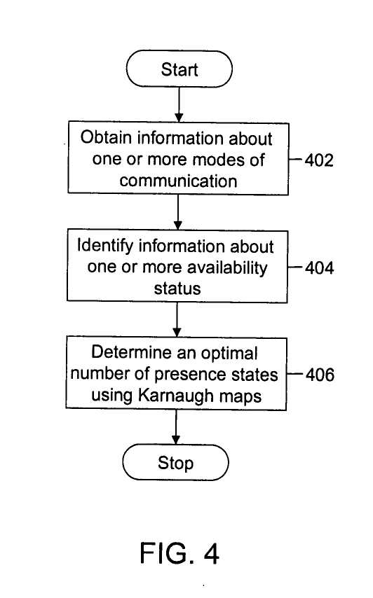

FIG. 3 is a schematic diagram illustrating presence display icon 302 in user interface 206, in accordance with an exemplary embodiment of the invention. Presence display icon 302 may be displayed on a display screen and displays information about presence states of one of users 106, 108 and 110, hereinafter referred to as user 106, by way of example only. In accordance with various embodiments of the invention, presence display icon 302 displays presence states of more than one user. These presence states indicate the availability status of user 106 for each mode of communication. However, the optimal number of presence states are displayed on presence display icon 302. The optimal number of presence states are determined by using means for determining optimal number of presence states. In accordance with various embodiments of the invention, a processing machine may be provided for determining the optimal number of presence states. The processing machine is capable of taking input values and processing the input values to determine the optimal number of presence states. The processing machine determines the optimal number of presence states by using Karnaugh maps approach. An exemplary method for determining the optimal number of presence states is discussed in detail in conjunction with FIG. 4.

Presence display icon 302 may be communicatively coupled to a storage module 304, a control unit 306, and a display module 308. Storage module 304 stores the optimal number of presence states. Control unit 306 interacts with receiver 204 to get information pertaining to the current presence state of user 106. The current presence state of user 106 indicates the current availability status of user 106 for each mode of communication. Thereafter, control unit 306 compares information about the current presence state with the presence states stored in storage module 304. Based on this comparison, control unit 306 identifies the current presence state of user 106. Further, corresponding to the identified current presence state, a glyph is displayed by display module 308. A glyph comprises a symbol that conveys non-verbal information. The display icon 302 may have glyphs which correspond to the following states: no available, available for voice, available for voice and video, busy on voice call, busy on call with voice and video. The last two glyphs may be combined to just busy. Thus, the display icon 302 may have at least 4 glyphs, with each glyph comprising a distinct visual representation of a presence state. This representation can depend on the functionalities of user interface 206. Examples of these functionalities include a text mode glyph, the Light Emitting Diodes (LEDs) of different colors, and the like. The number of glyphs is equal to the optimal number of presence states of user 106.

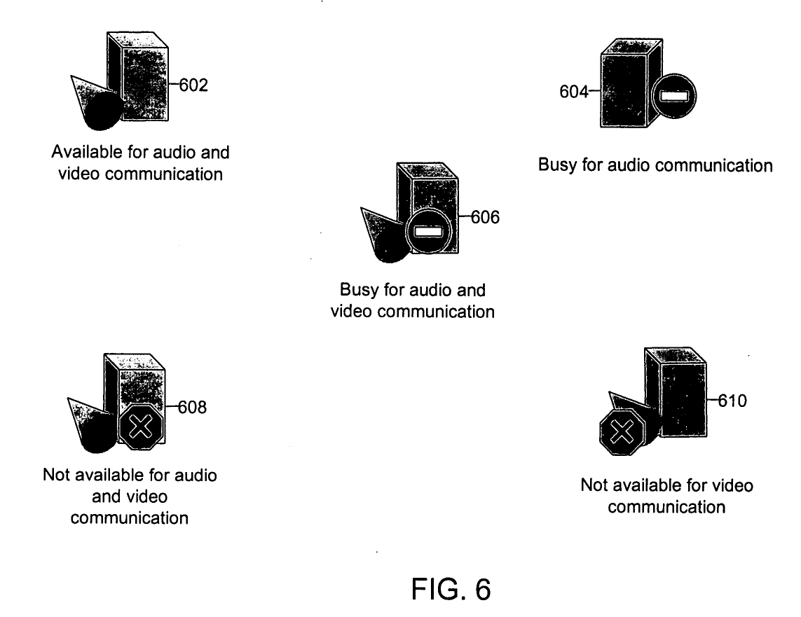

In accordance with various embodiments of the invention, storage module 304 and control unit 306 are embodied in an external device that controls the working of presence display icon 302. In an embodiment of the invention, the external device can be a processing system. In an embodiment of the invention, control unit 306 can be implemented as a part of software, hardware and their combination thereof Further, in an embodiment of the invention, user interface 206 can be a graphical user interface. Exemplary display icons having glyphs of different shades and/or colors have been illustrated in FIG. 6.

FIG. 4 illustrates a flowchart of a method for determining the optimal number of presence states, in accordance with an exemplary embodiment of the invention. At step 402, information about one or more modes of communication is obtained. In an embodiment of the invention, the information about modes of communication can include number of modes of communication and types of modes of communication. Thereafter, at step 404, information about one or more availability status corresponding to each mode of communication is identified. In an embodiment of the invention, the information pertaining to availability status can include the number of availability status and types of availability status. In an embodiment of the invention, the types of availability status include available, non-available and busy. Further, at step 406, based on the information related to modes of communication and their respective availability status, the optimal number of presence states are determined using Karnaugh maps. Each presence state indicates the availability status of a user for each mode of communication, for example, a presence state can indicate that user 106 is available for audio communication and not available for video and text communication.

In accordance with various embodiments of the invention, a processing machine is provided for performing the above-mentioned method steps. The processing machine is capable of taking input values and processing the input values to determine the optimal number of presence states.

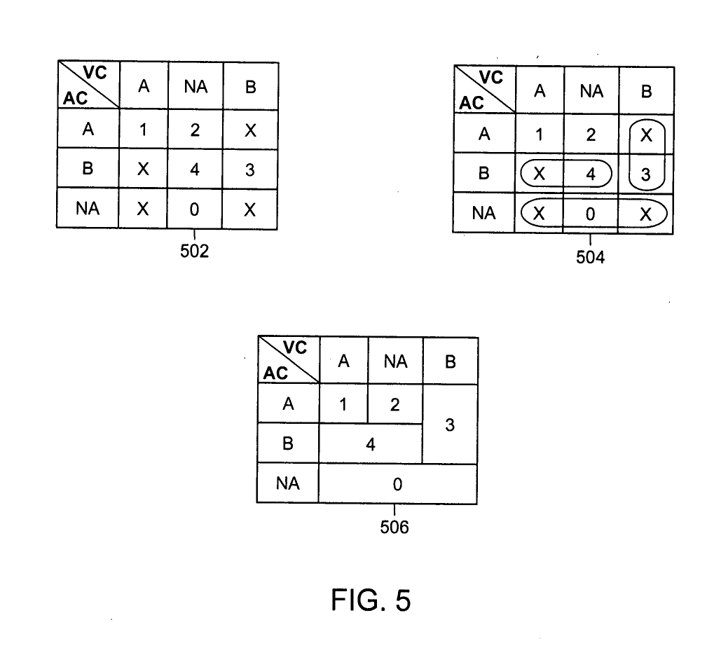

FIG. 5 illustrates an exemplary Karnaugh map, used for determining the optimal number of presence states, in accordance with an exemplary embodiment of the invention. Karnaugh maps are used to obtain the minimum number of terms for a given output of a function. The function relates an output to various combinations of input variables. Each combination of input variables corresponds to a term in the function. Karnaugh maps, with the help of design logic, are used for identifying the terms that influence the output of the function. Karnaugh maps can further be used for incompletely specified functions. The incompletely specified functions represent situations when certain combinations of input variables cannot take place. Hence, the output corresponding to these combinations does not affect the final output of the function. Based on design logic, the output corresponding to these combinations can be chosen, to obtain an optimal solution.

In the exemplary embodiment, two modes of communication are considered as the input variables. The two modes of communication are video communication (VC) and audio communication (AC). Each mode of communication has three availability status: available (A), not available (NA), and busy (B). As a result, there are nine total possible presence states. Therefore, the original function contains nine terms. However, based on the design requirements of presence display icon 302, some combinations of the modes of communication and availability status cannot occur.

A Karnaugh map corresponding to these nine presence states is shown as a table 502. The numeric value in each cell corresponds to a unique presence state. Presence state {0} represents a state where user 106 is not available for audio and video communication. Presence state {1} represents a state where user 106 is available for audio as well as video communication. Presence state {2} represents a state where user 106 is available for audio communication and not available for video communication. Presence state {3} represents a state where user 106 is busy for both audio and video communication. Presence state {4} represents a state where user 106 is busy for audio communication and not available for video communication. Further, presence state ‘X’ represents a state in which the combination cannot occur. For example, if user 106 is not available for audio communication, it is assumed that user 106 cannot be available or busy for video communication. Similarly, when user 106 is busy for video communication, user 106 cannot be available for audio communication. Thereafter, based on design requirements, the Xs are combined with their adjacent numeric values, to determine the optimal terms in the function.

The Karnaugh map, with combined values, is shown in table 504. The X corresponding to user 106 being not available for audio communication and available for video communication and the X corresponding to user 106 being not available for audio communication and busy for video communication are combined with the presence state in which user 106 is not available for both audio and video communication. This is because it is desirable that if user 106 is not available for audio communication, user 106 is also not available for video communication. Similarly, the X corresponding to the presence state, when user 106 is available for audio communication and busy for video communication, can be combined with the presence state in which user 106 is busy for audio and video communication.

Table 506 represents a Karnaugh map, where the optimal presence states are shown. The final function of the presence states is provided below.
Presence state={0}+{1}+{2}+{3}+{4}

The presence state {0} indicates that user 106 is not available for audio communication, and therefore, not available for video communication as well. Presence state {1} indicates that user 106 is available for audio as well as video communication. Presence state {2} indicates that user 106 is available for audio communication, but is not available for video communication. Presence state {3} indicates that user 106 is busy in another video communication. Presence state {4} indicates that user 106 is busy in another audio communication. Hence, the total number of presence states required is determined as five. This is the optimal number of presence states that represent information pertaining to all the possible nine presence states of user 106. In accordance with an embodiment of the invention (based on the design requirements), the presence states {3} and {4} can be combined as single presence state {3}, which indicates that user 106 is busy. Hence, the optimal number of presence states in this embodiment can be four. The optimal number of presence states can vary, depending on the design requirements of presence display icon 302.

Referring back to FIG. 3, the optimal number of presence states are stored in storage module 304. Control unit 306 receives information about the current presence status of user 106 from receiver 204. Based on the received information, control unit 306 extracts the presence state corresponding to the current presence status of user 106. Thereafter, the glyph corresponding to the current presence state is displayed at display module 308. For example, if the current presence state of user 106 is {0}, then a glyph corresponding to {0} can be displayed, and first user 102 can know that user 106 is not available for audio as well as video communication.

In accordance with various embodiments of the invention, presence display icon 302 can be used to display the presence state of one of communication devices 112, 114 and 116.

FIG. 6 depicts, by way of illustration only, an exemplary embodiment of a display icon having glyphs of different shades and/or colors. The display icon of FIG. 6 includes a tear drop member having two glyphs and a rectangular member having three glyphs. As shown in the figure, an encircled ‘−’ indicates a busy state, while an encircled ‘X’ indicates non-available state. For example, as shown in FIG. 6, glyph 602 indicates a state in which user 106 is available for both audio and video communication. Glyph 604 indicates that user 106 is busy for audio communication. Glyph 606 indicates that user 106 is busy for both audio and video communication. Glyph 608 indicates that user 106 is not available for either audio or video communication. Glyph 610 indicates that user 106 is not available for video communication. As previously suggested, the display icon may be any suitable icon having any suitable optimal number of glyphs for conveying non-verbal information.

Embodiments of the present invention have the advantage that a single presence display icon can be provided to display information pertaining to presence states in a plurality of modes of communication. This saves screen real estate and therefore allows more information to be displayed on a small screen. This also makes it faster and easier for users to understand. This is because a single display icon solution maps more naturally to how the brain perceives information. Further, the presence display icon only displays the optimal number of presence states. This maximizes the rate of information transfer between the presence display icon and the user's brain, because the optimal number of presence states is less than 7±2. Consequently, the human brain can easily comprehend the information displayed on the presence display icon.

Although the invention has been discussed with respect to specific embodiments thereof, these embodiments are merely illustrative, and not restrictive, of the invention. For example, a ‘method for determining the optimal number of presence states’ can include any type of analysis, manual or automatic, to anticipate the needs of the method.

Although specific protocols have been used to describe embodiments, other embodiments can use other transmission protocols or standards. The present invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Also in the description herein for embodiments of the present invention, a portion of the disclosure recited in the specification may contain material, which is subject to copyright protection. Computer program source code, object code, instructions, text or other functional information that is executable by a machine may be included in an appendix, tables, figures or in other forms. The copyright owner has no objection to the facsimile reproduction of the specification as filed in the Patent and Trademark Office. Otherwise all copyright rights are reserved.

A ‘computer’ for purposes of embodiments of the present invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. A ‘computer program’ may include any suitable locally or remotely executable program or sequence of coded instructions which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting video streams, such as on a display screen of the computer, the computer would have suitable instructions (e.g., source code) for allowing a user to display video streams in accordance with the embodiments of the present invention. Similarly, if a computer is employed for presenting other media via a suitable directly or indirectly coupled input/output (I/O) device, the computer would have suitable instructions for allowing a user to input or output (e.g., present) program code and/or data information respectively in accordance with the embodiments of the present invention.

A ‘computer readable medium’ for purposes of embodiments of the present invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable‘instructions for synchronously presenting multiple video program ID streams, such as on a display screen, or for providing for input or presenting in accordance with various embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A user interface for communication, comprising a presence display icon displaying presence states of at least one user and defined by a Karnaugh map for determining an optimal number of presence states.

2. The user interface of claim 1 wherein the presence states indicate availability of the user for one or more modes of communication, each mode of communication comprising one or more availability status.

3. The user interface of claim 2 wherein the modes of communication are selected from a group consisting of video communication, audio communication and text communication.

4. The user interface of claim 2 wherein the availability status are selected from a group consisting of available, not-available and busy.

5. The user interface of claim I wherein said presence display icon comprises at least four glyphs.

6. The user interface of claim 5 wherein said four glyphs are symbols representing the group consisting of: not available, available for voice, available for voice and video, busy on voice call, busy on call with voice and video, and a combination of busy on voice call and busy on call with voice and video.

7. A user interface for communication, the user interface comprising a presence display icon for displaying presence states of at least one user, wherein an optimal number of presence states are determined by a method comprising
obtaining information about one or more modes of communication;
identifying information about one or more availability status, the availability status corresponding to the modes of communication; and
determining the optimal number of presence states, wherein the optimal number of presence states are determined using a Karnaugh map, each presence state being a combination of the mode of communication and the availability status.

8. The user interface of claim 7 wherein the information about one or more modes of communication comprises
number of modes of communication; and
types of modes of communication.

9. The user interface of claim 7 wherein the information about one or more availability status comprises
number of availability status; and
types of availability status.

10. The user interface of claim 8 wherein the types of modes of communication are selected from a group consisting of video communication, audio communication and text communication.

11. The user interface of claim 9 wherein the types of availability status are selected from a group consisting of available, not-available and busy.

12. A communication device for communicating with at least one user, the communication device comprising
a transmitter for establishing communication with the user;
a receiver for receiving information about presence state of the user; and
a user interface for displaying presence states of the user, wherein optimal number of presence states are determined using a Karnaugh map.

13. The user interface of claim 12, wherein the presence states indicate availability of the user for one or more modes of communication, each mode of communication comprising one or more availability status.

14. The user interface of claim 13, wherein the modes of communication are selected from a group consisting of video communication, audio communication and text communication.

15. The user interface of claim 13, wherein the availability status are selected from a group consisting of available, not-available and busy.

16. A method for selecting an optimal number of presence states of at least one user, the method comprising
obtaining information about one or more modes of communication;
identifying information about one or more availability status, the availability status corresponding to the modes of communication; and
determining the optimal number of presence states, wherein the optimal number of presence states are determined using a Karnaugh map, each presence state being a combination of the mode of communication and the availability status.

17. A system for selecting an optimal number of presence states of at least one user, the system comprising
means for obtaining information about one or more modes of communication;
means for identifying information about one or more availability status, the availability status corresponding to the modes of communication; and
means for determining an optimal number of presence states, wherein the optimal number of presence states are determined using a Karnaugh map, each presence state being a combination of the mode of communication and the availability status.

18. An apparatus for selecting an optimal number of presence states of at least one user, the apparatus comprising
a processor; and
a machine-readable medium including instructions executable by the processor comprising
one or more instructions for obtaining information about one or more modes of communication;
one or more instructions for identifying information about one or more availability status, the availability status corresponding to the modes of communication; and
one or more instructions for determining the optimal number of presence states, wherein the optimal number of presence states are determined using a Karnaugh map, each presence state being a combination of the mode of communication and the availability status.

19. A machine-readable medium including instructions executable by a processor for selecting an optimal number of presence states of at least one user, the machine-readable medium comprising
one or more instructions for obtaining information about one or more modes of communication;
one or more instructions for identifying information about one or more availability status, the availability status corresponding to the modes of communication; and
one or more instructions for determining the optimal number of presence states, wherein the optimal number of presence states are determined using a Karnaugh map, each presence state being a combination of the mode of communication and the availability status.
